(19) United States
(12) Patent Application Publication
(10) Pub. No.: US 2009/0089473 A1
(43) Pub. Date: Apr. 2, 2009

(54) Data transmission system and method thereof

(76) Inventor: Wangping He, Shanghai City (CN)

Correspondence Address: ROSENBERG, KLEIN & LEE, 3458 ELLICOTT CENTER DRIVE-SUITE 101, ELLICOTT CITY, MD, 21043, US

(21) Appl. No.: 12/078,486

(22) Filed: Apr. 1, 2008

Related U.S. Application Data
(60) Provisional application No. 60/976,581, filed on Oct. 1, 2007.

(51) Int. Cl. G06F 13/00

(52) U.S. Cl. 710/300

(57) ABSTRACT

The invention uses a SGPIO bus as an optional route for the communication between the two SAS expanders to guarantee high communication performance. Furthermore, two GPIO buses are used respectively as receiver and transmitter of the SGPIO so as to achieve synchronous data transmission between two SAS expanders.

### BACKGROUND OF THE INVENTION

1. Field of the Invention

The invention generally relates to a method for communication using SGPIO, and more particularly, to a method for communication between SAS expanders in a SAS JBOD product.

2. Description of the Related Art

Referring to FIG. 1, an expander 10 has a SCLOCK pin, a SLOAD pin, a SDATAIN pin and a SDATAOUT pin. A device 20 with FPGA or CPLD has a SCLOCK pin, a SLOAD pin, a SDATAIN pin, a SDATAOUT pin. The pins of the expander 10 are respectively connected to the corresponding pins of the device 20. The expander 10 is an initiator of a SGPIO bus 30. The other pins of the device 20 are used as GPIO bus. Therefore, the expansion of GPIO bus for the device 20 can be achieved by using the expander 10. The SGPIO bus 30 is used to expand the GPIO bus as well. In a conventional communication system using the SGPIO bus, if the SGPIO bus 30 is not to be applied to expand the GPIO bus, it will become idle due to not compatible with other applications.

For SAS JBOD products, communication between I/O control cards needs to be achieved for concern of dual-card application. In order to guarantee high communication performance, two communication paths, such as inter integrated circuit (I2C) bus or universal asynchronous receiver transmitter (UART) bus, are commonly used. However, the I2C or USRT buses of the currently available SAS expanders cannot satisfy the requirements for high communication performance. For I2C bus as example, the SAS expander would not work if the only communication path of the I2C bus malfunctions.

### SUMMARY OF THE INVENTION

It is an object of the invention to provide a SGPIO bus communication system in which when the SGPIO is idle, it can be used for communication between two SAS expanders, as an optional route for dual-card communication to solve the problem of inadequate bus space for I2C or UART and to guarantee high communication performance for dual-card application.

In order to achieve the above and other objectives, the communication system of the invention guarantees high performance by using a SGPIO bus which is not designed for dual-card communication application, even though there is an inadequate space for I2C or UART. The SGPIO bus which is not designated for I/O communication needs synchronous transmission, for both transmitter and receiver, between the SAS expanders. Therefore, two GPIO buses are used in the invention to assist the SGPIO to achieve the synchronous transmission.

The SAS expanders which both are initiators of the SGPIO bus use the SGPIO bus to exchange data or messages. The corresponding SCLOCK pins and the respective SLOAD pins of the respective SAS expanders are not connected to each other, while a SDATAOUT pin of one expander is connected to a SDATAIN pin of the other expander and a SDATAIN pin of one expander is connected to a SDATAOUT pin of the other expander. Therefore, when one SAS expander outputs the data to its SDATAOUT pin, it also informs the other expander at the same time. Meanwhile, the other SAS expander sets its SLOAD pin at LOW so as to read the data via its SDATAIN pin. The other SAS expander transmits the data to one SAS expander in the similar way.

To provide a further understanding of the invention, the following detailed description illustrates embodiments and examples of the invention, this detailed description being provided only for illustration of the invention.

### BRIEF DESCRIPTION OF THE DRAWINGS

FIG. 1 is schematic layout of a conventional SGPIO bus communication system.

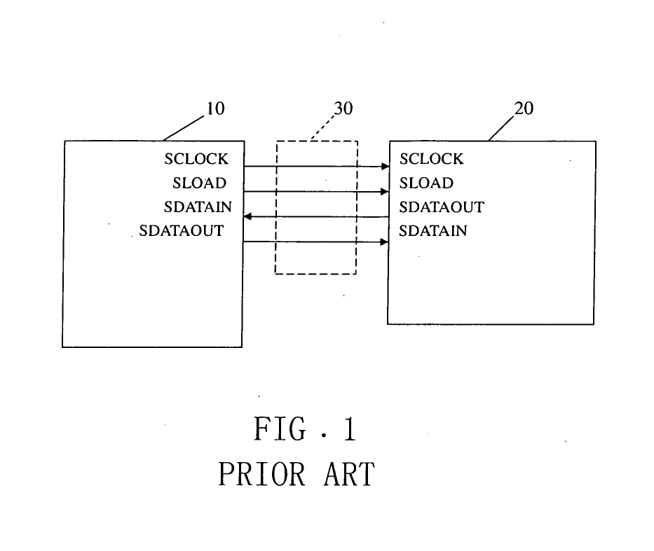

FIG. 2 is a schematic layout of a SGPIO bus communication system according to one embodiment of the invention.

FIG. 3 is a flow chart of a method of communication using a SGPIO bus according to one embodiment of the invention.

### DETAILED DESCRIPTION OF THE EMBODIMENTS

Wherever possible in the following description, like reference numerals will refer to like elements and parts unless otherwise illustrated.

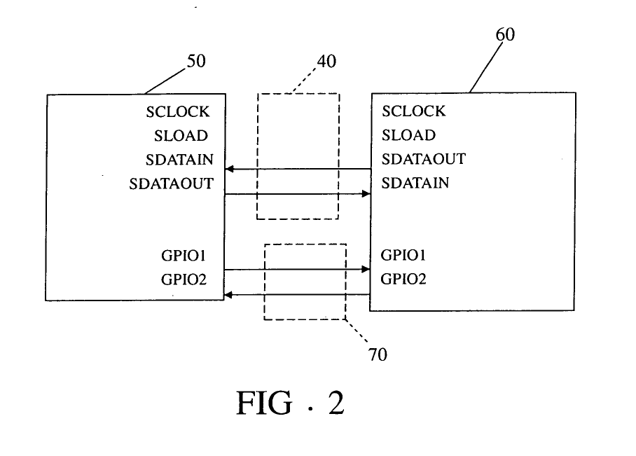

FIG. 2 is a schematic layout of a SGPIO bus communication system according to one embodiment of the invention. A SGPIO bus 40 is used for communication between a first expander 50 and a second expander 60. In the prior art, it is difficult to use the SGPIO bus 40 for communication between the first expander 50 and second expander 60, because both of the expanders 50, 60 are initiators of SGPIO bus 40. Furthermore, the protocol of the SGPIO bus 40 fails to cope with the communication between both SGPIO initiators. The data will be lost when both of the SGPIO initiators initiate data access at the same time.

With further preference to FIG. 2, a SCLOCK pin and a SLOAD pin of each of the expanders 50, 60 are not to be functioned in order to solve the above problem. That means the SCLOCK and SLOAD pins of the first expander 50 fail to contact with the SCLOCK and the SLOAD pins of the second expander 60, preventing from lowering down the potential of the SLOAD pin of the second expander 60 when the first expander 50 is reading data or lowering down the potential of the SLOAD pin of the first expander 50 when the second expander 60 is reading data. For synchronous data access, two GPIO pins 70 in addition to the SGPIO bus 40 need to connect between the expanders 50, 60.

When the expander 50 is about to write the data into the expander 60, the expander 60 will be informed in advance via one of the GPIO pins 70. After the expander 60 has been informed, the data sent from a SDATAOUT pin of the expander 50 is read via a SDATAIN pin of the expander 60. Similarly, the expander 60 is about to write the data into the expander 50, the expander 50 will be informed in advance via one of the GPIO pins 70. After the expander 50 has been informed, the data sent from a SDATAOUT pin of the expander 60 is read by a SDATAIN pin of the expander 50.

Therefore, the invention can be used for communication between two SAS expanders when the SGPIO is idle, as an optional route for dual-card communication. The SGPIO bus offers the optional route when some problems occur in I2C or UART routes, so as to enhance performance of dual-card communication.

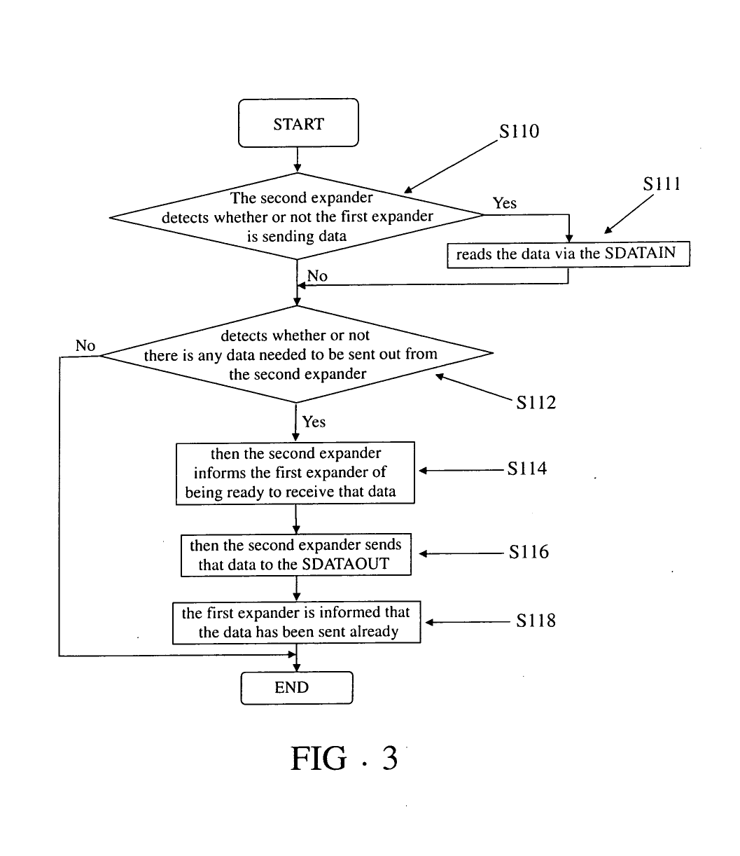

FIG. 3 is a flow chart of a method of communication using SGPIO according to one embodiment of the invention. The expanders can be operated in any sequence, not limited to the sequence as exemplified below. The second expander 60 judges if the first expander 50 is sending the data (S110). If YES for the step 110, then the expander 60 via its SDATAIN pin read the data sent from a SDATAOUT pin of the expander 50 (S111). If NO for the step 110, then the expander 60 judges if there is any data needed to be sent out from it (S112). If NO for the step S112, then end the data transmission between the two expanders 50 and 60. If YES for the step 112, then the second expander 60 informs the first expander 50 of being ready to receive that data via its GPIO2 (S114). Then the second expander 60 will send that data to its SDATAOUT (S116). Via the GPIO pin 70 of the second expander 60, the first expander 50 is informed that the data has been sent already (S118).

In light of the foregoing, the invention uses SGPIO bus as an option for the communication between the two SAS expanders to guarantee high communication performance even though there is space inefficiency for I2C or UART buses. Furthermore, two GPIO buses are used respectively as receiver and transmitter of the SGPIO so as to achieve synchronous data transmission between two SAS expanders.

It should be apparent to those skilled in the art that the above description is only illustratives of specific embodiments and examples of the invention. The invention should therefore cover various modifications and variations made to the herein-described structure and operations of the invention, provided they fall within the scope of the invention as defined in the following appended claims.

What is claimed is:

1. A data transmission system comprising
a first expander;
a second expander;
an SGPIO bus, connected between the first expander and the second expander for serial data transmission therebetween; and
a GPIO bus connecting the first expander to the second expander for acknowledged signal transmission therebetween,
wherein the first expander and the second expander transmit data to each other via the SGPIO bus and transmit acknowledged signals to each other after the data has been received via the GPIO bus.

2. The data transmission system of claim 1, wherein the first expander is an expander with serial attached SCSI bus.

3. The data transmission system of claim 1, wherein the second expander is an expander with serial attached SCSI bus.

4. The data transmission system of claim 1, wherein the SGPIO bus has a data input port (SDATAIN) and a data output port (SDATAOUT) for serial data transmission between the first and second expanders.

5. The data transmission system of claim 1, wherein the GPIO has two communication pins for acknowledged signal transmission between the first and second expanders.

6. The data transmission system of claim 1, wherein two of the standard SGPIO bus ports, port SCLK and port SLOAD, are not used.

7. A method of transmitting data between a first expander and a second expander via a SGPIO bus, the method comprising:
a. the first expander detects whether or not the second expander is sending the data using a GPIO bus;
b. if YES for the step a, then the first expander reads the data sent from the second expander via the GPIO bus;
c. if NO for the step a, then the first expander detects whether or not there is any data needed to be sent out;
d. if YES for the step c, then the first expander informs the second expander via the GPIO bus of being ready to receive the data; and
e. the first expander transmits the data to the second expander via the SGPIO.

8. The method of claim 7, wherein the first expander detects via the first communication pin of the GPIO whether or not the second expander is sending the data.

9. The method of claim 7, wherein the first expander reads via the SDATAIN of the SGPIO the data sent from the second expander.

10. The method of claim 7, wherein the first expander informs via the second communication pin of GPIO the second expander of being ready to receive the data.

11. The method of claim 7, wherein the first expander sends the data to the second expander via the SDATAOUT of the SGPIO.

12. The method of claim 7, wherein if NO is the result of step c, the data transmission between the two expanders is ended.

13. The method of claim 7, wherein two of the standard SGPIO bus ports, port SCLK and port SLOAD, are not used.
